(19) United States
(12) Patent Application Publication
(10) Pub. No.: US 2007/0163083 A1
(43) Pub. Date: Jul. 19, 2007

(54) Hinge housing for door leaves which are made at least in some areas from thin-walled metal or metal hollow sections

(75) Inventor: Torsten Eberl, Muhltal (DE)

Correspondence Address: NORRIS, MCLAUGHLIN & MARCUS, P.A., 875 THIRD AVE, 18TH FLOOR, NEW YORK, NY, 10022, US

(73) Assignee: MEPLA-WERKE LAUTENSCHLAEGER GMBH & CO. KG, Reinheim (DE)

(21) Appl. No.: 10/596,337

(22) PCT Filed: Dec. 8, 2004
(86) PCT No.: PCT/EP04/13920

§ 371 Date: Jun. 9, 2006

(30) Foreign Application Priority Data
Dec. 11, 2003 (DE) 203 19 267.2

(51) Int. Cl. E05D 5/00

(52) U.S. Cl. 16/382

(57) ABSTRACT

The invention relates to a hinge housing constructed as a push-in cup which can be installed countersunk in an opening in the inner face of the wall of a door leaf of a piece of furniture formed in the installation region from thin-walled metal, wherein the hinge housing has a cup part produced from metal and has projecting integrally from its upper edge a fixing flange which in the properly installed position on the door leaf covers the region of the inner face of the door leaf adjoining the opening in the door leaf and wherein the hinge housing has a liner plate which is disposed between the fixing flange and the inner face of the door leaf, has a corresponding opening for the cup part to pass through in the region of the opening in the door leaf and can be fixed together with the hinge housing on the inner face of the door leaf.

The invention relates to a hinge housing constructed as a push-in cup which can be installed countersunk in an opening in the inner face of the wall of a door leaf of a piece of furniture formed in the installation region from thin-walled metal, wherein the hinge housing has a cup part produced from metal and has projecting integrally from its upper edge a fixing flange which in the properly installed position on the door leaf covers the region of the inner face of the door leaf adjoining the opening in the door leaf and wherein the hinge housing has a liner plate which is disposed between the fixing flange and the inner face of the door leaf, has a corresponding opening for the cup part to pass through in the region of the opening in the door leaf and can be fixed together with the hinge housing on the inner face of the door leaf.

The construction of hinge housings of modem multi-joint furniture hinges of the type concerned here which serve as a door leaf mounting part and can be fixed countersunk in an opening in the inner face of a door leaf made from wood material of a cupboard, i.e. a hinge housing composed of a cup part made from metal with a fixing flange and a liner part made from plastics material which is practically invisible after fixing on or in the door leaf, has been increasingly successful in recent times. Thus the metal part which is produced either from metal sheet using a punch pressing process or a die-casting process from a metal alloy on the one hand determines the appearance of the hinge housing and on the other hand ensures the necessary load-bearing capacity, whilst the plastics liner part which in the assembled state is not or hardly visible ensures the precise alignment of the metal part in the opening in the door leaf. In this case the fixing of the hinge housing on the door leaf takes place as a rule by means of one or two fixing screws which pass through countersunk fixing bores in the fixing flange of the metal part and recesses in the part of the plastics liner lying below them and are either screwed directly into the door leaf or engage in fixing lugs provided on the liner part which for their part are retained in fixing bores drilled into the wood material of the door leaf spaced from the opening for the cup part. These fixing lugs which are preferably injection moulded integrally on the liner part are oversized with respect to the internal diameter of the fixing bore in the door leaf so that they connect the installed hinge housing firmly to the door leaf. Due to the construction of the fixing lugs in the manner of expanding dowels which can be expanded by the fixing screws screwed into them, the firm seating of the hinge housing on or in the door leaf can be further improved. However, removal of the hinge housing from the door leaf is possible by unscrewing the fixing screw(s), since then the connection of the metal part to the liner part is released. However, this screwing operation is labour-intensive and if the metal part is released from and reconnected to the liner part a number of times the screw threads of the fixing screws in the fixing lugs or—where these are not provided—in the walls of the fixing bores in the door leaf, so that the firm seating and secure retention on the door leaf is impaired. Reference is made to the hammer-set housing known from DE 26 36 767 C2 as an example of the known hinge housing.

In addition to furniture made from wood materials, in recent times furniture made from metal sheet has become increasingly successful—for example in the office sector—in which the door leaves are frequently of double-walled construction at least in the edge region for aesthetic reasons and for reinforcement. Door leaves made up using metal hollow chamber sections are also gaining in interest. Hinges with the known hinge housings intended for fixing on wooden door leafs cannot be attached to such metal door leaves.

The fixing of hinge housings on such metal doors is made possible by a hinge housing of the type referred to in the introduction (DE 41 42 988 A1), in which a thin liner plate is disposed between the fixing flange of the metal part and the outer face of the wall of the door leaf made from the metal sheet and this liner plate is fixed in an appertaining through opening in the wall of the door leaf. For the connection of the metal cup part to the liner plate rotary latches are then provided which latch the metal cup part after insertion into the through opening in the pre-installed liner plate by rotation in the manner of a bayonet catch. In any case it should be emphasised that the installation of the hinge cup on the door leaf requires a rotary movement of the cup part in the preinstalled liner plate, which is only possible when the carcass mounting part of the hinge provided with the known hinge cup has not yet been mounted on the carcass of the piece of furniture.

By contrast, the object of the invention is to create a hinge housing of the type in question here, which allows the door leaf to be removed even when the hinge is preinstalled on the cupboard carcass without it first being necessary to remove the hinge from the supporting wall of the carcass. Furthermore, it should also be possible to insert the hinge cup according to the invention even in those cases where the receiving space available for the cup part of the hinge housing in the interior of the door leaf below the metal inner wall only has a small depth, so that the cup part must also be of correspondingly low construction.

Starting from a hinge housing of the type mentioned in the introduction this object is achieved according to the invention in that the liner plate has in the edge region of its opening corresponding to the opening in the wall of the door leaf resilient latching tabs which project into the opening in the door leaf and which in the proper fixing position of the liner plate on the inner face of the wall engage so as to latch around the edge region of the opening in the door leaf, that in the liner plate at least two through openings spaced from one another are provided in alignment with the respective associated through opening in the wall of the door leaf, that in alignment with the through openings in the liner plate and the wall of the door leaf through openings are provided in the fixing flange through which the shanks of fixing screws are passed, the end regions of the fixing screws remote from the screw head and provided with a screw thread being screwed in each case into a complementary matching thread in a clamping plate, the outer boundary of which corresponds substantially to the outer boundary of the opening in the wall of the door leaf, and that between the flat face of the liner plate facing the wall of the door leaf and the boundary surfaces of the clamping plates facing it there is disposed in each case a resiliently deformable fixing body through which the shank of the fixing screw passes and which in the undeformed state has an outer boundary which corresponds substantially to the boundaries of the openings in the wall of the door leaf as well as the clamping plate. The fixing of the hinge housing on or in the door part then takes place in such a way that the cup part of the push-in cup with the liner plate previously disposed on the underside of the fixing flange is introduced into the opening of the door leaf. At the same time the fixing lugs formed by the fixing screws spaced from one another with resilient fixing bodies put on and retained by a clamping plate on the shank thereof are introduced through the associated openings in the door leaf wall. After the underside of the liner plate has been placed on the wall of the door leaf the resilient latching tabs provided on the liner plate then secure the hinge cup against inadvertent retraction, although removal is possible by increased traction on the hinge cup in the direction out of the opening in the door leaf wall. The firm and highly loadable fixing of the hinge cup in the opening of the wall of the door leaf then takes place in such a way that the fixing screws are turned in the sense of screwing into the clamping plate. In this case the distance between the heads of the fixing screws lying on the upper face of the fixing flange and the clamping plates is reduced, as a result of which the resiliently deformable fixing bodies are compressed and thereby forcibly widened in diameter. Then the fixing bodies of enlarged diameter can no longer be retracted through the openings in the door leaf wall and ensure the secure retention of the hinge cup in the installed position.

In an advantageous variant of the invention the through openings in the liner plate extend centrally through centring lugs which project from the flat side of the liner plate facing the wall of the door leaf and of which the outer boundaries correspond in each case in a complementary manner to the boundaries of the respective associated through openings in the door leaf wall and of which the length is at most equal to the thickness of the wall. These centring lugs ensure that when the hinge cup is installed on or in the door leaf it is installed in the necessary exactly aligned rotated position, wherein the selected length of the centring lugs ensures that the resilient fixing bodies which increase in diameter as the fixing screws are tightened engage behind the inner face of the wall in the door leaf so that axial play of the installed hinge cup in the opening in the door leaf cannot occur.

In a preferred embodiment of the invention a plurality of resilient latching tabs are provided which from the underside of the liner plate are distributed over the circumference of the opening thereof and engage in a latching manner around the opening in the door leaf wall in the proper installation position. It is ensured thereby that already during the pre-installation of the hinge cup without tightened fixing screws the underside of the liner plate and thus the fixing flange of the hinge housing covering the liner plate are drawn onto the outer face of the wall of the door leaf without play. Thus an additional pressing of the hinge cup onto the door leaf wall during the actual fixing process by screwing in of the fixing screws is not then necessary.

In a preferred embodiment of the invention, in the proper installation position in the opening in the door leaf wall the cup part of the housing has a shape which is flattened laterally on two opposing regions, whereby the underside of the base and the outer faces of the flattened area of the cup part are engaged around by a thin-walled joint support made from metal which has a U-shaped cross-section, which is displaceable relative to the cup part parallel to the flattened area thereof and to the base and in which receiving bores are provided for the bearing lugs of toggle joints to be articulated pivotably in the hinge housing. In this case the end regions of the arms of the U of the joint support are passed through slots extending in the direction of displacement thereof in the fixing flange and project from the upper face of the fixing flange, wherein the receiving bores for at least one of the toggle joints to be articulated pivotably are constructed in the end regions of the arms of the U of the joint support projecting from the fixing flange and means are provided for fixing the joint support in selectable displacement positions relative to the cup part. Due to the provision of the receiving bores for the bearing pins of the toggle joints of an appertaining hinge on the joint support and the displaceability thereof relative to the hinge cup retained immovably in the door leaf the door leaf is horizontally adjustable relative to the carcass. In other words, a change in the butting dimension of an overlying door leaf or of the gap between the vertical boundary edge of the door leaf and the vertical inner face of the carcass supporting wall with the door leaves inlaid is possible on the door leaf side.

On the other hand, the receiving bores for at least one further toggle joint to be articulated pivotably on the hinge housing are preferably provided in regions of the arms of the U of the joint support which engage around the outer faces of the cup part and lie below the fixing flange, whereby in the flattened wall regions of the cup part in alignment with the receiving bores in the arms of the U of the joint support elongate through slots are provided which extend in the direction of displacement of the joint support and of which the width is substantially equal to the diameter of the appertaining receiving bore in the joint support. When the bearing journals for the appertaining toggle joint to be articulated on are installed the bearing journals pass through the elongate slots in the flattened wall regions of the cup part, whereby stress acting in the hinge cup by way of the toggle joint is removed by way of the edges of the elongate slot in the cup part onto the cp part.

At least a part of the latching tabs disposed in the region of the lateral flattened area of the cup part in the proper installation position has in the free end region thereof a thickened head portion which projects in the direction towards the flattened areas and which is guided in each case into abutment on the outer flat faces of the arms of the U of the joint support facing away from the cup part. Thus the arms of the U of the joint support are not only guided on their inner faces on the flattened areas of the walls of the cup but in addition are also guided on the opposing outer face by the thickened head portions of the latching tabs.

The means for fixing the joint support in selectable displacement positions are preferably constructed in such a way that at least a part of the latching tabs disposed in the region of the lateral flattened area of the cup part in the proper installation position has in the free end region thereof a thickened head portion which projects in the direction towards the flattened areas and which is guided in each case into abutment on the outer flat faces of the arms of the U of the joint support facing away from the cup part. The end of the eccentric portion lying in the interior of the cup part is then advantageously provided with an actuating head like a screw head which is enlarged in diameter. When the actuating head like a screw head is turned by means of a suitable tool, e.g. a screwdriver, then the eccentric movement of the eccentric portion is then supported by way of the opposing edges of the elongate transverse slot in the base of the cup part and accordingly by way of the lug mounted in the web portion of the joint support is converted into a displacement movement of the joint support.

The invention is explained in greater detail in the following description of an embodiment in conjunction with the drawings, in which:

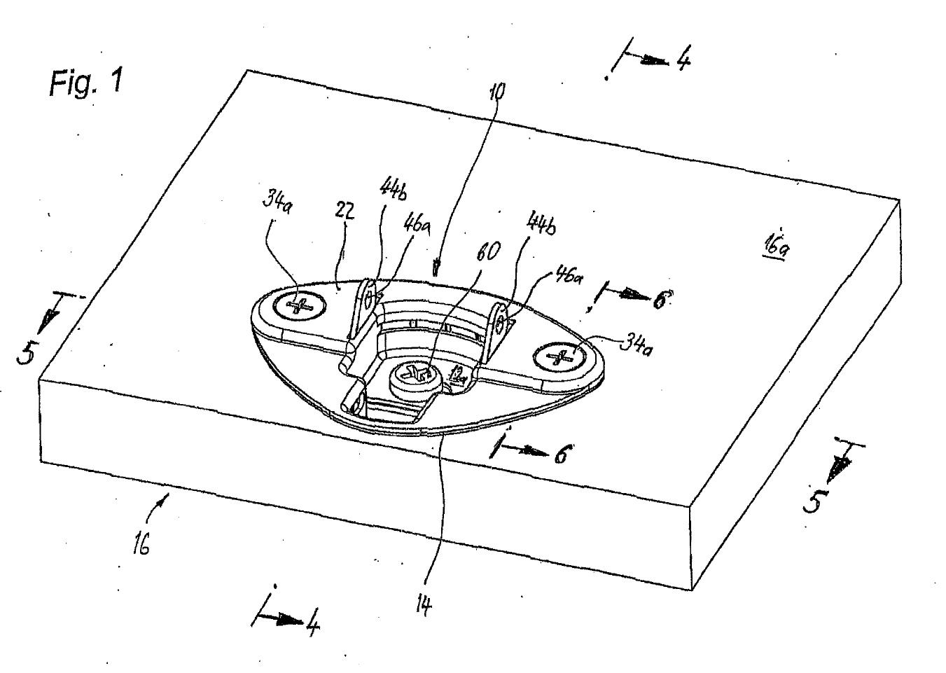

FIG. 1 shows an isometric view of a hinge housing constructed in the manner according to the invention in the proper fixing position on the wall of a door leaf—shown only in a partial view—which is constructed in the fixing region as a thin-walled hollow section;

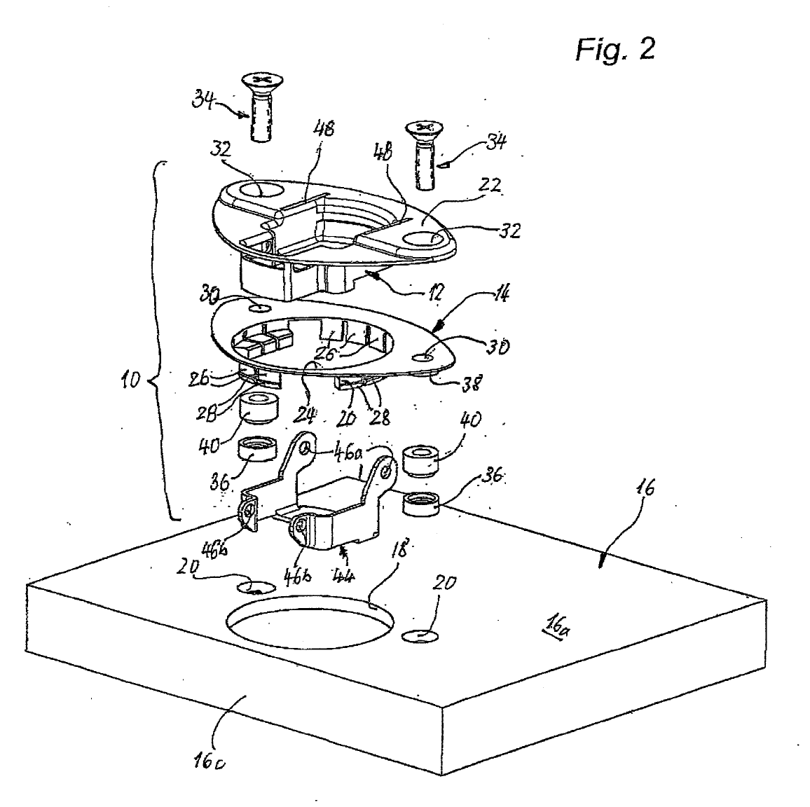

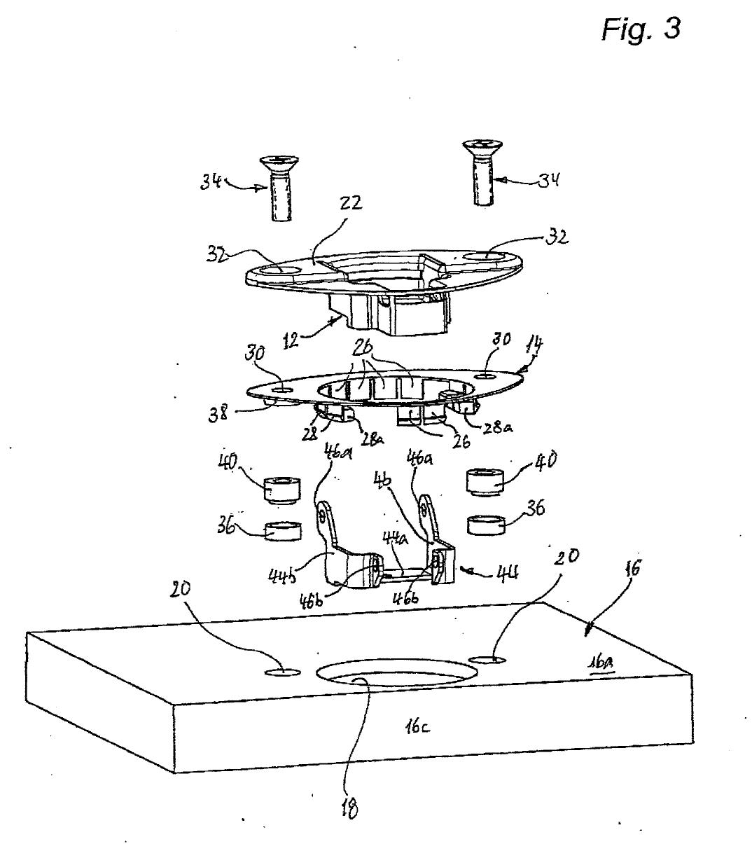

FIGS. 2 and 3 each show isometric exploded views of the hinge housing and of the appertaining portion of the door leaf from different viewing directions;

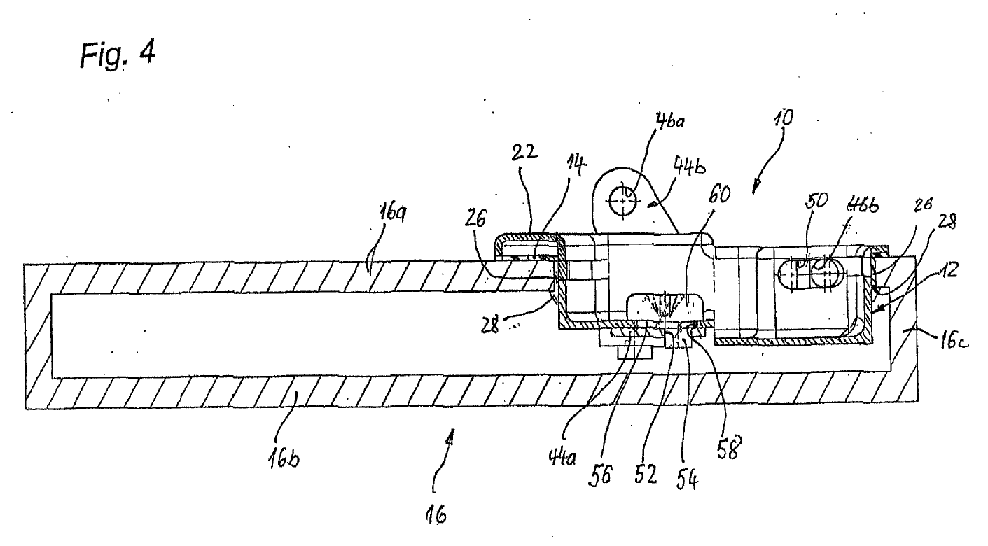

FIG. 4 shows a sectional view in the direction of the arrows 4-4 in FIG. 1;

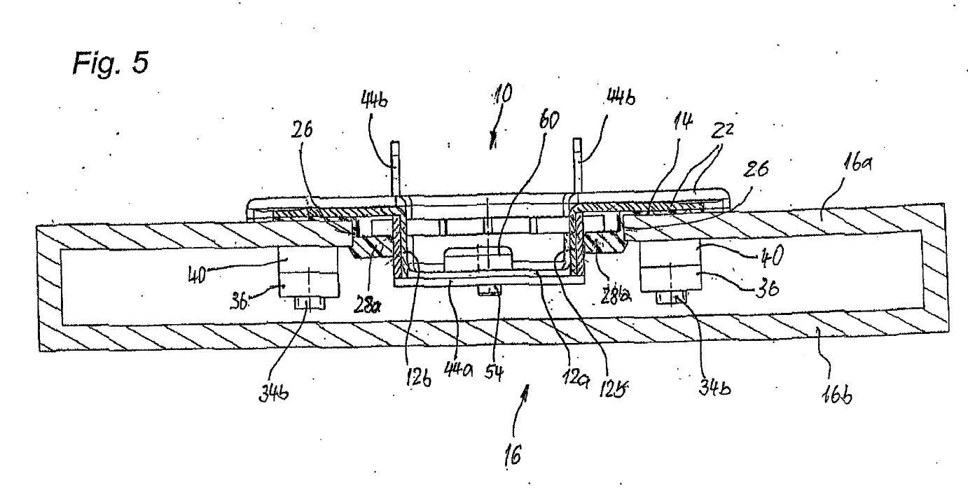

FIG. 5 shows a sectional view in the direction of the arrows 5-5 in FIG. 1; and

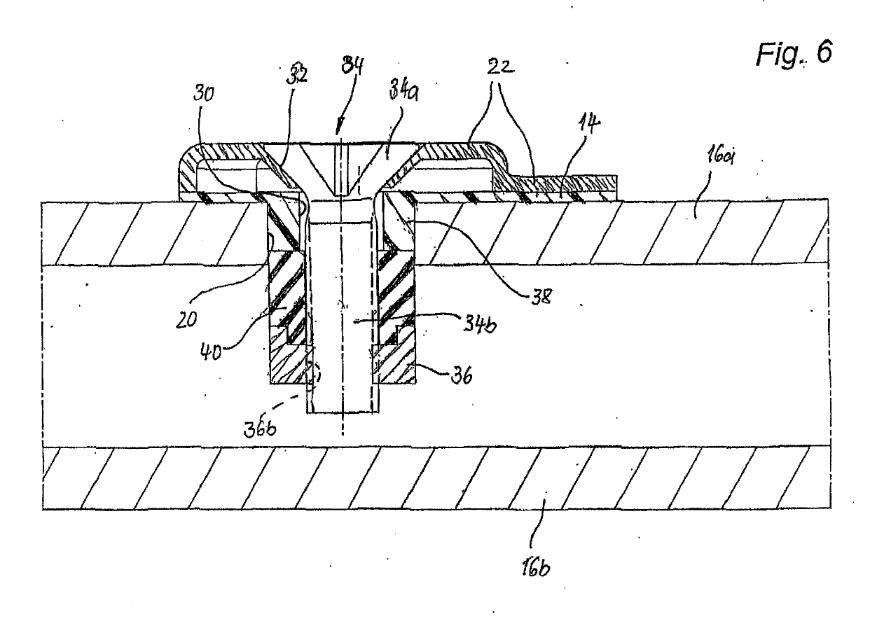

FIG. 6 shows a partial sectional view in the direction of the arrows 6-6 in FIG. 1.

The hinge housing shown in the drawings and denoted as a whole by 10 is composed of a cup part 12 which is made from metal and is explained in greater detail below in conjunction with FIGS. 2 and 3 and a liner plate 14 made from plastics material. The hinge housing 10 forms the door leaf mounting part of a jointed hinge—otherwise not shown—in the special case of a four-joint hinge with which a door leaf 16 made from metal sheet is articulated pivotably on a cupboard carcass.

The hinge housing 10 is intended for countersunk fixing in a double-walled edge region of the door leaf 16, wherein 16a denotes the wall which is inside the carcass when the door leaf is closed and 16b denotes the outer wall, both of which are retained a relatively small predetermined distance apart by the end wall 16c forming the lateral boundary of the door leaf so that a relatively flat hollow space is produced between the wall 16a and 16b.

For the fixing of the hinge housing 10 the punched or drilled through openings which are illustrated in particular in FIGS. 2 and 3 are provided in the wall 16a, namely an opening 18 delimited by a circle in the immediate vicinity of the end wall 16c of the door leaf and—at a greater distance from the end wall 16c—two circular through openings 20 of smaller diameter. The through openings 20 of smaller diameter lie symmetrically with respect to the centre line of the opening 18 extending at right angles to the boundary edge of the door leaf.

The cup part 12 made from metal has on its upper edge a fixing flange 22 which in the proper installation position on the door leaf 16 covers the regions of the wall 16a adjoining the opening 18. The cup part which in this case is introduced through the opening 18 into the interior of the door leaf 16, i.e. positioned countersunk in the interior of the door leaf, has the shape of a laterally flattened dish.

The thin flat lining plate 14 made from plastics material which in its outer boundary is shaped substantially corresponding to the shape of the fixing flange 22 has an opening 24 corresponding to the opening 18 in the wall 16a of the door leaf. In the edge region of this opening 24 resiliently deformable latching tabs 26 which are injection moulded on integrally project from the flat face of the liner plate 14 lying opposite the fixing flange 22 and which are provided on their free ends with latching heads 28 which are in each case directed radially outwards and which in the proper installation position of the hinge housing in the opening 18 engage in a latching manner behind the inner face of the wall 16a.

The liner plate 14 has two through openings 30 which are spaced from one another and of which the centre line in the installed position is aligned with the centre line of the respective associated through opening 20 in the wall 16a. Also in the fixing flange 22 through openings 32 which are aligned with the through openings 30 of the liner plate and the through openings 20 of the wall 16a are provided which in the illustrated case (FIG. 6) are countersunk and serve to receive the countersunk head 34a of a respective fixing screw 34, the shank 34b of which provided with a thread is screwed in each case into a complementary matching thread 38b in a clamping plate 36. Projecting from the flat side of the liner plate 14 facing the wall 16a of the door leaf are short centring lugs 38 which concentrically enclose the through openings 30 in the liner plate 14 and of which the external diameter corresponds substantially equally to the diameter of the through openings 20 in the wall 16a. The centring lugs 38 are somewhat shorter in length than the wall thickness of the wall 16a, so that in the proper installation position of the liner plate on the wall 1a they do not project into the hollow space of the door leaf.

A resiliently deformable fixing body 40 through which the shank of the fixing screw 34 passes is disposed between the free end faces of the centring lugs 38 of the liner plate 14 and the clamping plates 36, and in the undeformed state it has a diameter which likewise corresponds to the diameter of the through openings 20 in the wall 16a. As can be seen in particular in FIG. 6, the centring lugs which can each be inserted into one of the appertaining through openings 20, the subsequent resiliently deformable fixing body 40 and the clamping plate 36 screwed onto the free end of the threaded shank 34b together form a fixing lug which in the initial state shown in FIG. 6 can be introduced fittingly through the through openings 20 in the wall 16a into the interior of the door leaf 16. Then when in the proper bearing position of the liner plate on the wall 16a the head 34a of the fixing screw 34 is turned in the sense of screwing the threaded shank 34b into the thread 36b of the clamping plate 36 the clamping plate 36 is screwed on the shank 34 in the direction of the inner face of the wall 16a. The resilient fixing body 40 is compressed thereby and then inevitably bulges outwards as its diameter increases. Depending upon the degree of bulging the resilient fixing body then engages behind the edge regions of the inner face of the wall 16a adjoining the through openings 20, as a result of which a positive-locking of the fixing flange on the wall 16a of the door leaf is obtained which absorbs shocks to a large extent due to the resilient properties of the fixing body 40.

By rotation of the head 34a of the fixing screw 34 in the opposite direction the clamping plate 36 is screwed again in the direction of the free end of the shank 34b, whereby the resilient fixing body 40 lengthens and its bulge recedes again until it assumes the original cylindrical shape. In this state the fixing lugs which are formed by the centring lugs 38 of the liner plate 14, the resilient fixing body 40 and the clamping plate 3 in collaboration with the fixing screw 34 can be withdrawn without force from the through opening 20 in the wall 16 of the door leaf 16 and the hinge housing can be removed.

The cup part 12 of the hinge housing 10 is—as already mentioned—constructed as a dish which is flattened on opposite sides. The underside of the base 12a of this cup part and the outer faces of the flattened areas 12b of the cup part 12 are surrounded by a thin-walled metal joint support 44 of U-shaped cross-section which is displaceable relative to the cup part parallel to and on the lateral flattened areas 12b thereof and the underside of the base 12a thereof. Bearing bores 46a, 46b for the bearing lugs of toggle joints (not shown) which are to be articulated pivotably on the hinge housing side in or on the hinge housing are provided in this joint support. The joint support 44 of U-shaped cross-section has a web portion 44a which engages with contact under the base 12a of the cup part 12, wherein from the boundaries thereof lying in the region of the flattened areas 12b a U-shaped arm 44b in each case is bent round substantially at right angles. In the case of the hinge housing described above and illustrated in the drawings the arms 44b of the U are longer than the height of the lateral flattened areas 12b of the cup part measured at right angles to the wall 1a. Therefore slots which extend in the direction of displacement of the joint support 44 and through which the upper end region of each arm 44b of the U is passed are provided in the fixing flange 22. The receiving bores 46a for at least one of the toggle joints to be articulated pivotably on the hinge housing are provided in the end regions of the arms 44b of the U of the joint support 44 projecting upwards over the fixing flange 22. Further receiving bores 46b for at least one further toggle joint to be articulated in the hinge housing are provided in the regions of the arms 44b of the U of the joint support 44 which lie below the fixing flange 22 and engage around the outer faces of the cup part 12. In order that the bearing pin to be retained in these receiving bores 46b can be installed with its ends in the arms of the U, elongate slots 50 (FIG. 4) are additionally provided in the laterally flattened regions 12b of the cup part 12 in alignment with the receiving bores 46b in the arms 44b of the U, these slots extending in the direction of displacement of the joint support and being dimensioned in terms of width corresponding substantially to the diameter of the appertaining receiving bore 46b. It is clear that on the one hand the length of the slots 48 passing through the fixing flange 22 and on the other hand the length of the elongate slots 50 in the laterally flattened wall regions 12b of the cup part must be dimensioned at least corresponding the desired displacement path of the joint support 44 relative to the cup part 12.

It can be seen in particular in FIGS. 2 and 3 that latching tabs 26 are integrally attached over substantially the entire circumference of the opening 24, wherein the latching projections 28 which engage round the wall 16a so as to latch in the interior project from the outer ends of the latching tabs. It can also be seen that a part of the latching tongues 26 which in the proper installation position are disposed in the region of the lateral flattened areas 12b of the cup part 12 each have in their free end region a thickened head portion 28a which projects in the direction towards the flattened areas 12b and is guided until it butts against the outer flat faces of the arms 44b of the U of the joint support 44 facing away from the cup part. Thus in the region of the head parts 28a the arms 44b of the U of the joint support 44 are guided in the direction of displacement on both sides, that is to say by the flattened areas 12b of the cup part 12 on the one hand and the abutting flat faces of the head parts 28a on the other hand.

In a bearing bore 52 of the web portion 44a of the joint support 44 extending below the base 12a of the cup part 12 there is rotatably mounted a lug 54 which projects from the underside of an eccentric portion 56 which is delimited by a circle, enlarged in diameter and offset eccentrically with respect to the axis of rotation of the lug 54, the peripheral surface of the eccentric portion being supported on the opposing long edges of an elongate transverse slot 58 in the base 12a. In the interior of the cup part 12 the eccentric portion 56 is provided with an actuating head 60 like a screw head which is enlarged in diameter and which is provided for example with the recess which is shown in FIG. 1 and—by dash-dot lines—in Figure for the application of a tool for a Phillips screwdriver. Thus by turning of the actuating head 60 with a Phillips screwdriver the joint support 44 can be moved progressively around the predetermined displacement path. By appropriate configuration the possibility created in this way for adjustment of the joint support by the eccentric adjustment can be of self-locking construction. However, if necessary additional clamping for an implemented adjustment of the joint support 44 can be additionally created by a clamping screw (not shown) screwed into a threaded bore in the base 12 and pressed onto the web portion 44a of the joint support 44.

1. Hinge housing (10) constructed as a push-in cup which can be installed countersunk in an opening (18) in the inner face of the wall (16a) of a door leaf (16) of a piece of furniture formed in the installation region from thin-walled metal, wherein the hinge housing has a cup part (12) produced from metal and has projecting integrally from its upper edge a fixing flange (22) which in the properly installed position on the door leaf (16) covers the region of the inner face of the door leaf adjoining the opening (18) in the door leaf and wherein the hinge housing has a liner plate (14) which is disposed between the fixing flange (22) and the inner face of the door leaf, has a corresponding opening (24) for the cup part (12) to pass through in the region of the opening (18) in the door leaf (16) and can be fixed together with the hinge housing on the inner face of the door leaf (16), characterised in that the liner plate (14) has in the edge region of its opening (24) corresponding to the opening (18) in the wall (16a) of the door leaf (16) resilient latching tabs (26) which project into the opening (18) in the door leaf (16) and which in the proper fixing position of the liner plate (1) engage around the edge region of the opening (18) in the door leaf (16) so as to latch on the inner face of eh wall, that in the liner plate (14) at least two through openings (30) spaced from one another are provided in alignment with the respective associated through opening (20) in the wall (16a) of the door leaf(16), that in alignment with the through openings (30; 20) in the liner plate (14) and the wall (16a) of the door leaf (16) through openings (32) are provided in the fixing flange (22) through which the shanks (34b) of fixing screws (34) are passed, the end regions of the fixing screws remote from the screw head (34a) and provided with a screw thread being screwed in each case into a complementary matching thread (36b) in a clamping plate (36), the outer boundary of which corresponds substantially to the outer boundary of the opening (20) in the wall (16a) of the door leaf (16), and that between the flat face of the liner plate (14) facing the wall (16a) of the door leaf (16) and the boundary surfaces of the clamping plates (36) facing it there is disposed in each case a resiliently deformable fixing body (40) through which the shank (34b) of the fixing screw (34) passes and which in the undeformed state has an outer boundary which corresponds substantially to the boundaries of the openings (20) in the wall of the door leaf as well as the clamping plate (36).

2. Hinge housing as claimed in claim 1, characterised in that the through openings (30) in the liner plate (14) extend centrally through centring lugs (38) which project from the flat side of the liner plate (14) facing the wall (16a) of the door leaf (16) and of which the outer boundaries correspond in each case in a complementary manner to the boundaries of the respective associated through openings (20) in the door leaf wall (16a) and of which the length is at most equal to the thickness of the wall (16a).

3. Hinge housing as claimed in claim 1, characterised in that a plurality of resilient latching tabs (26) are provided which project from the underside of the liner plate (14), are distributed over the circumference of the opening (24) thereof and engage in a latching manner around the opening (18) in the door leaf wall (16a) in the proper installation position.

4. Hinge housing as claimed in claim 1, characterised in that in the proper installation position in the opening (18) in the door leaf wall (16c) the cup part (12) of the housing has a shape which is flattened laterally on two opposing regions, that the underside of the base (12a) and the outer faces of the flattened area (12b) of the cup part (12) are engaged around by a thin-walled joint support (44) made from metal which has a U-shaped cross-section, which is displaceable relative to the cup part (12) parallel to the flattened area (12b) thereof and to the base (12a) and in which receiving bores (46a; 46b) are provided for the bearing lugs of toggle joints to be articulated pivotably in the hinge housing (10), that end regions of the arms (44b) of the U of the joint support (44) are passed through slots (48) extending in the direction of displacement thereof in the fixing flange (22) and project from the upper face of the fixing flange, wherein the receiving bores (46a) for at least one of the toggle joints to be articulated pivotably are constructed in the end regions of the arms (44b) of the U of the joint support (44) projecting from the fixing flange (22), and that means are provided for fixing the joint support (44) in selectable displacement positions relative to the cup part (12).

5. Hinge housing as claimed in claim 4, characterised in that the receiving bores (46b) for at least one further toggle joint to be articulated pivotably on the hinge housing are preferably provided in regions of the arms (44b) of the U of the joint support (44) which engage around the outer faces of the cup part (12) and lie below the fixing flange (22), and that in the flattened wall regions (12b) of the cup part (12) in alignment with the receiving bores (46b) in the arms of the U of the joint support elongate through slots (50) are provided which extend in the direction of displacement of the joint support (44) and of which the width is substantially equal to the diameter of the appertaining receiving bore (46b) in the joint support (44).

6. Hinge housing as claimed in claim 4, characterised in that at least a part of the latching tabs (26b) disposed in the region of the lateral flattened area (12b) of the cup part (12) in the proper installation position has in the free end region thereof a thickened head portion (28a) which projects in the direction towards the flattened areas (12b) and which is guided in each case into abutment on the outer flat faces of the arms (44b) of the U of the joint support (44) facing away from the cup part.

7. Hinge housing as claimed in claim 4, characterised in that in a bearing bore (52) of the web portion (44a) of the joint support (44) extending below the base (12a) of the cut part (12) there is rotatably mounted a lug (54) which projects from the underside of an eccentric portion (56) which is enlarged in diameter and offset with respect to the axis of rotation of the lug (54) and of which the peripheral surface is supported on the opposing long edges of an elongate transverse slot (5) in the base (12a) of the cup part (12).

8. Hinge housing as claimed in claim 7, characterised in that the end of the eccentric portion (56) lying in the interior of the cup part bears an actuating head (60) like a screw head which is enlarged in diameter.
